(19) United States
(12) Patent Application Publication
(10) Pub. No.: US 2019/0151045 A1
(43) Pub. Date: May 23, 2019

(54) Device and Methods for Disinfecting Dental Lines

(71) Applicant: Owen BOYD, Scottsdale, AZ (US)

(72) Inventor: Owen BOYD, Scottsdale, AZ (US)

(73) Assignee: Toppen Medical Dental LLC, Holliston, MA (US)

(21) Appl. No.: 16/155,964

(22) Filed: Oct. 10, 2018

Related U.S. Application Data
(60) Provisional application No. 62/590,029, filed on Nov. 22, 2017.

(51) Int. Cl. A61C 1/00; C02F 1/78; B01J 19/00

(52) U.S. Cl. CPC A61C 1/0076; C02F 1/78; C01B 13/0207; B01J 2219/00824; B01J 19/0093

(57) ABSTRACT

Described is a combination method, including a device and system for disinfecting and decontaminating water lines, for example, dental water lines, in the absence of a primary chemical component.

### REFERENCE TO RELATED APPLICATIONS

This application claims priority to and the benefit of U.S. Provisional Patent Application Ser. No. 62/590,029, filed Nov. 22, 2017, the entire disclosure of which is incorporated herein by reference.

### FIELD OF THE INVENTION

This disclosure relates to a combination method, including a device and methods, for disinfecting and decontaminating, for example, dental water lines.

### BACKGROUND OF THE INVENTION

In-line water lines, e.g., dental water lines, have a high surface area, a high temperature, and a low flow rate, rendering them susceptible to growth of microorganisms such as but not limited to bacteria. Such in-line water lines are also susceptible to development of biofilms. As such, these water lines pose risks to human health. These risks are of particular importance where water lines are employed in sanitation and/or medical applications, including for example, dental water lines.

Chemical and other methods of disinfecting water lines are known. However, available methods have the undesirable effects of causing corrosion in water lines or other aspects of water lines, including pumps and related machinery. Available methods also employ undesirable chemical aerosols, and require time- and cost-intensive protocols to achieve disinfection of water lines.

Accordingly, there is need for time- and cost-effective systems and methods for disinfecting water lines, for example dental water lines, that avoid corrosive or other environmentally undesirable reagents and that effectively achieve disinfection of water in the line and/or elimination of biofilm in the line. Systems and methods are also needed that maintain a disinfected state in water lines, for example dental water lines, and prevent formation of biofilm.

### BRIEF SUMMARY OF THE INVENTION

Disclosed herein are water line decontamination and disinfection systems. The disclosed systems comprise an ozone treatment coupled with a chemical treatment of water in a water line. The ozone treatment can be a primary disinfection that precedes the chemical treatment, or the ozone treatment can be a secondary disinfection that follows the chemical treatment.

In some embodiments, the chemical treatment comprises a disinfecting media containing a cation-on-cation-on-cation surface to which the water in the water line is subjected.

The system can be used to decontaminate and/or disinfect any water line. In some embodiments, the water line is a dental water line.

In the systems disclosed herein, the ozone treatment and the chemical treatment can be administered to the water in an in-line cartridge. The in-line cartridge can comprise an inlet, an outlet, and a body. The chemical treatment can comprise a disinfecting media disposed in the body of the cartridge. The disinfecting media can include a substrate comprising alumina, silicate, or combinations thereof, and a cationic coating disposed on the substrate. The cationic coating can include one or more of AgO, Ag₂O, and AgC.

In some embodiments, the disclosed systems comprise a sensor for detecting a concentration of ozone in the water. The systems can further comprise a control board or other electronic control system configured to receive a signal from the sensor and stop a flow of fluid in response to the concentration of ozone being outside a predetermined concentration range, for example, from about 0.5 mg/L to about 2.0 mg/L of ozone in the water.

Also disclosed are cartridges for disinfecting water, the cartridges comprising an inlet, an outlet, a body, and a disinfecting media disposed in the body, the disinfecting media including a substrate comprising alumina, silicate, or combinations thereof; and a cationic coating disposed on the substrate, the cationic coating including one or more of AgO, Ag₂O, and AgC. In some embodiments, the cartridges comprise a substrate that is granulated, and the disinfecting media comprises a cationic surface.

Also disclosed are methods of disinfecting fluid, the methods comprising generating a flow of fluid, and conveying the flow of fluid through a cartridge, the cartridge including an inlet, an outlet, a body, and a disinfecting media disposed in the body, the disinfecting media including a substrate comprising alumina, silicate, or combinations thereof; and a cationic coating disposed on the substrate, the cationic coating including one or more of AgO, Ag₂O, and AgC.

### BRIEF DESCRIPTION OF THE DRAWINGS

The foregoing summary, as well as the following detailed description of preferred embodiments of the present application, will be better understood when read in conjunction with the appended drawings. It should be understood, however, that the application is not limited to the precise embodiments shown in the drawings.

FIG. 1A-FIG. 1C depict an example cartridge that can be used in an embodiment of the invention. FIG. 1A shows an electrolytic ozone cell that can be implemented in a water line, for example, coupled to the cartridge shown in FIG. 1B. FIG. 1C is an exploded view of the cartridge shown in FIG. 1B.

FIG. 2 is a schematic drawing of a simplified dental care unit suitable for use with an embodiment of the invention.

FIG. 3 is a flow diagram of a method for controlling the system for providing disinfected water in accordance with an embodiment of the invention.

FIG. 4 is an electrical schematic diagram of the system for providing disinfected water in accordance with an embodiment of the invention.

FIG. 5 is a scanning electron micrograph of disinfecting media suitable for use with an embodiment of the invention.

FIG. 6 is a scanning electron micrograph of disinfecting media according to an embodiment of the invention showing electronic discharge in response to exposure of an electronic potential of 15.0 kV for 55 seconds.

FIG. 7 is a chart plotting nitrate concentration in mg/L up-stream and down-stream of the cartridge according to FIG. 1 over 11 months.

### DETAILED DESCRIPTION

Various publications, articles and patents are cited or described in the background and throughout the specification; each of these references is herein incorporated by reference in its entirety. Discussion of documents, acts, materials, devices, articles or the like which has been included in the present specification is for the purpose of providing context for the invention. Such discussion is not an admission that any or all of these matters form part of the prior art with respect to any inventions disclosed or claimed.

Unless defined otherwise, all technical and scientific terms used herein have the same meaning as commonly understood to one of ordinary skill in the art to which this invention pertains. Otherwise, certain terms used herein have the meanings as set forth in the specification.

It must be noted that as used herein and in the appended claims, the singular forms “a,” “an,” and “the” include plural reference unless the context clearly dictates otherwise.

Unless otherwise stated, any numerical values, such as a concentration or a concentration range described herein, are to be understood as being modified in all instances by the term “about.” Thus, a numerical value typically includes ±10% of the recited value. For example, a concentration of 1 mg/mL includes 0.9 mg/mL to 1.1 mg/mL. Likewise, a concentration range of 1% to 10% (w/v) includes 0.9% (w/v) to 11% (w/v). As used herein, the use of a numerical range expressly includes all possible subranges, all individual numerical values within that range, including integers within such ranges and fractions of the values unless the context clearly indicates otherwise.

Those skilled in the art will recognize, or be able to ascertain using no more than routine experimentation, many equivalents to the specific embodiments of the invention described herein. Such equivalents are intended to be encompassed by the invention.

As used herein, the terms “comprises,” “comprising,” “includes,” “including,” “has,” “having,” “contains” or “containing,” or any other variation thereof, are intended to be non-exclusive or open-ended. For example, a composition, a mixture, a process, a method, an article, or an apparatus that comprises a list of elements is not necessarily limited to only those elements but can include other elements not expressly listed or inherent to such composition, mixture, process, method, article, or apparatus. Further, unless expressly stated to the contrary, “or” refers to an inclusive or and not to an exclusive or. For example, a condition “A or B” is satisfied by any one of the following: A is true (or present) and B is false (or not present), A is false (or not present) and B is true (or present), and both A and B are true (or present).

As used herein, the conjunctive term “and/or” between multiple recited elements is understood as encompassing both individual and combined options. For instance, where two elements are conjoined by “and/or,” a first option refers to the applicability of the first element without the second. A second option refers to the applicability of the second element without the first. A third option refers to the applicability of the first and second elements together. Any one of these options is understood to fall within the meaning, and therefore satisfy the requirement of the term “and/or” as used herein. Concurrent applicability of more than one of the options is also understood to fall within the meaning, and therefore satisfy the requirement of the term “and/or.”

As used herein, “subject” means any animal, preferably a mammal, most preferably a human. The term “mammal” as used herein, encompasses any mammal. Examples of mammals include, but are not limited to, cows, horses, sheep, pigs, cats, dogs, mice, rats, rabbits, guinea pigs, monkeys, humans, etc., preferably a human.

It should also be understood that the terms “about,” “approximately,” “generally,” “substantially,” and like terms, used herein when referring to a dimension or characteristic of a component of the invention indicate that the described dimension or characteristic is not a strict boundary or parameter and does not exclude minor variations therefrom that are functionally the same or similar, as would be understood by one having ordinary skill in the art. At a minimum, such references that include a numerical parameter would include variations that, using mathematical and industrial principles accepted in the art (e.g., rounding, measurement or other systematic errors, manufacturing tolerances, etc.), would not vary the least significant digit.

The inventive device and methods combines a primary disinfection and a secondary disinfection method and system to uniquely and effectively disinfect and decontaminate, e.g., dental water lines, and additionally to maintain a disinfected and decontaminated state in the water lines. The inventive method and chemistry provide versatile, efficient, and effective water line disinfection and treatment, and can eliminate and/or prohibit development of biofilm in water lines.

In some embodiments, the primary disinfection is a chemical treatment of the water in a water line, and the secondary disinfection is an ozone treatment of the water in the water line. However, the primary disinfection can be an ozone treatment while the secondary disinfection can be chemical treatment of the water in a water line.

In some embodiments, the primary disinfection is a chemical treatment that subjects the in-line water to a disinfectant and oxidant that does not form a by-product. In this aspect, treatment of the dental line water with ozone (O₃) is integral to the system. Beneficially, such ozone treatment is an environmentally friendly method, a “green” technology. However, ozone use alone may have problems because its efficacy depends on the quality of the water in the water line.

It will be understood by persons of ordinary skill in the art that the primary and secondary disinfections described herein can be alternated depending on their respective placement in a water line system. That is, depending on the position of the, e.g., ozone treatment apparatus with respect to the chemical treatment apparatus, the ozone treatment and/or the chemical treatment can readily be alternated to be the primary disinfection, while the other treatment remains the secondary disinfection, because of and depending on the direction of the flow of the water in the water line.

Normal generation of ozone is achieved by corona discharge generating microplasma ozone. This method is available for use in water line systems from, for example, EP PURIFICATION (Champagne, Ill., USA). Such ozone generation systems, however, require an ozone destruction system as a safeguard, especially in applications where exposure to high ozone concentrations may present hazards or health risks. The use of an electrolytic cell for ozone generation as described herein negates the need for an ozone destruction system.

In some embodiments, the secondary disinfection is a chemical treatment that uses a ceramic disinfecting media containing a cation-on-cation-on-cation surface to which the water in the water line is subjected. The ceramic disinfecting media can be, e.g., an AgO-Ag₂O-AgC surface. Alternative cation-on-cation-on-cation surfaces will be apparent to persons of ordinary skill in the art. The media, which in some embodiments can be QUANTUM DISINFECTION™ media (hereafter “disinfecting media” or simply “media”), is NSF-61 certified, available from CLAIRE TECHNOLOGIES (Raleigh, N.C., USA), and is described in U.S. Pat. No. 9,650,265, the disclosure of which is incorporated herein by reference in its entirety.

The methods and systems described herein with both primary and secondary disinfections can be used as follows. The dental water line first contacts the ozone treatment, then contacts the disinfecting media, then is delivered to hand piece(s) by which water is ejected or provided to, e.g., a patient during a dental procedure. This achieves continuous disinfection of the water line.

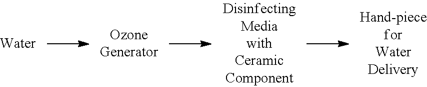

More specifically, in some embodiments of the methods and systems described herein, ozone is injected into the water container that is operatively connected to flow into a dental water line for delivery to hand piece(s) by which water is provided to the patient during a dental procedure or may be injected directly into the waterline via an electrolytic cell in dental units without water bottles. This achieves continuous disinfection and decontamination of the dental water line. In a preferred example, the electrolytic cell provides an anode and a cathode that is stabile in water, and the anode and cathode are separated by a membrane to place H₂ on one side of the membrane and O₃ on the other when electrified.

The ozone-treated water, prior to being made available to the hand piece, can be subjected to the secondary disinfection, wherein the secondary disinfection comprises a chemical method of contact with disinfecting media, a three-dimensional surface area of silicate SiO₂ ceramic or spheralite alumina Al₂O₃ ceramic. The ozone-treated water contacts the disinfecting media by passing over the media, generating a large flow or movement of electrons, resulting in the creation of catalytic sites that are ceramic germicidal surfaces on the media. These catalytic sites cause any bacteria that are present in the water line to lose their electrons, resulting in immediate lysis of the bacteria and resulting in their death.

In one embodiment, a cartridge for disinfecting water in water lines, e.g., dental line water, includes an inlet, an outlet, a body, and a disinfecting media disposed in the body. The disinfecting media includes a substrate with a cationic coating. The substrate includes alumina and/or silicate, and the cationic coating is disposed on the substrate and includes AgO, Ag₂O, and/or AgC.

In one embodiment, the disinfecting and decontaminating process generates a fluid flow of dental chair water that is conveyed through a cartridge, containing the components described herein.

Ozone used for either primary disinfection or secondary disinfection, depending on placement of the ozone cell, but coupled with a secondary chemical system, is new and beneficially solves problems with standard chemical systems. Using chemicals as the primary dental decontamination and disinfection methodology detrimentally corrodes steel and copper components of the system as well as alters the water chemistry to above EPA Safe Water Act limits for consumption. In contrast, using ozone as the primary dental decontamination and disinfection methodology beneficially does not corrode components, while maintaining EPA Safe Water Act limits. This is directly related to the low concentration of ozone used and the fact that ozone will break down into molecular oxygen, O₂. A concentration of 0.5 mg/L ozone provided to a dental water line achieves disinfection and decontamination, and then advantageously dissipates, with a t_{1/2}˜20 min, into molecular oxygen. Aerosols from chemicals create conditions that lead to respiratory, ocular, dermal pathologies among personnel in dental offices, but dissolved ozone, at 0.5 mg/L concentration, does not have this undesirable effect.

In some embodiments, the disclosed inventive methods and systems automate primary and secondary disinfection. In some embodiments, the disclosed inventive methods and systems produce dissolved ozone instantly on demand. In some embodiments, the disclosed inventive methods and systems eliminate the need to implement cost- and time-inefficient protocols required with chemical disinfection and decontamination as the primary source of disinfection. Such protocols include pretreatment time (1 hour/day/chair), hand piece water run-through time, chemicals added to chairside bottles, e.g., silver, iodine, water run-through time between patients, end of day water flush for each chair, etc. Chemical systems as primary disinfection systems are known to yield water having up to ˜100,000 colony forming units (cfu) per mL, and thus do not achieve a satisfactory level of disinfection and decontamination.

Embodiments of the inventive systems and methods vastly improve the current state of the art chemistry for disinfecting and decontaminating dental lines by replacing unwieldy and intensive chemical technologies with ozone technology coupled with efficient chemistry technology. Ozone (O₃) is a molecule that has a half-life of about 20 minutes (t_{1/2}˜20 min). Oxygen is produced upon dissipation.

In some embodiments, the systems and methods facilitate disinfection of a fluid flowing through dental lines and/or the disinfection of surfaces or articles coming into contact with a flow of disinfecting fluid generated by the systems and methods described herein.

The devices or cartridges described herein can include a housing for containing the disinfecting media. In one example, the device is a cartridge configured to allow a fluid to enter, pass through the media, and then exit while minimizing any loss of the media. The system includes the cartridge, and other such device for generating a fluid flow, and a device for controlling fluid flow. In a particular example, the system may include a dental care unit with a hand-held dispenser for delivering water or air to a patient. The inventive system and method improves disinfection and decontamination of dental lines, the fluid in the lines, and downstream articles that come into contact with the disinfected fluid. Thus, ease and efficiency of disinfecting and decontaminating dental lines is improved.

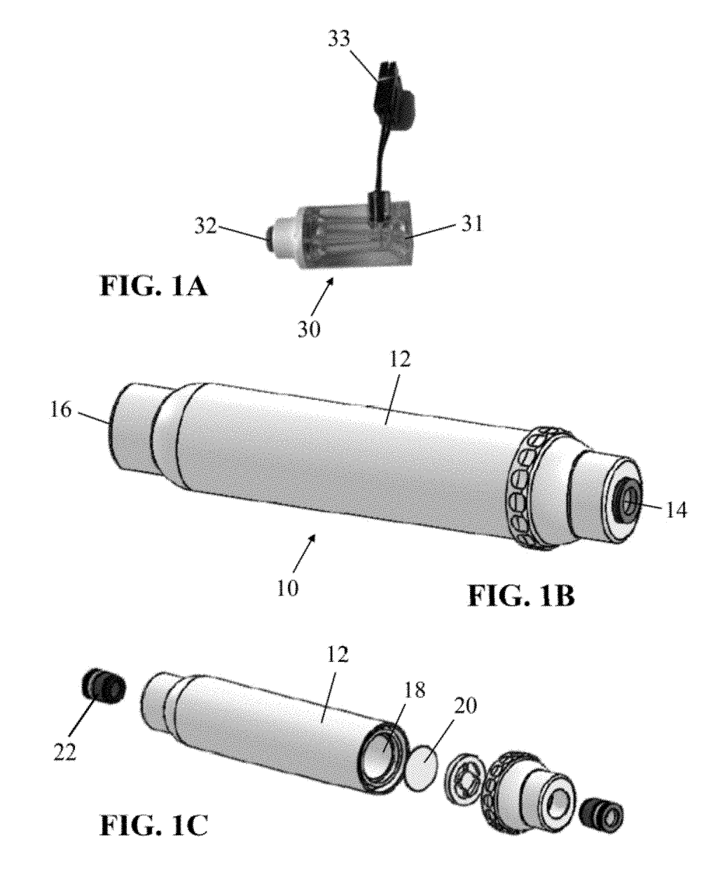

FIG. 1 depicts an exemplary cartridge 10 for use with an embodiment of the invention. FIG. 1A shows an electrolytic ozone cell that can be implemented in a water line, for example, coupled to the cartridge shown in FIG. 1B and FIG. 1C. FIG. 1B and FIG. 1C show cartridge 10 that includes a body 12, an inlet 14, and an outlet 16. Body 12 is configured to contain media 18 for disinfecting fluids such as water. In one example, media 18 may be configured to generate ozone in response to fluid flowing past media 18. Media 18 may be configured to facilitate a flow of fluid through the media, e.g., media may be porous, may include flow channels, may be granulated to facilitate fluid flow, etc. For example, with granulated media, the granules may be about 350 μm to about 4 mm in diameter or cross-sectional length. The media 18 may include a substrate comprising alumina, silicate, and combinations thereof and a cationic coating in/on the substrate, the cationic coating including AgO, Ag₂O, and AgC.

In use, water enters inlet 14, passes through the media 18, and exits outlet 16. While passing through the media 18, bacteria, virus, and spores are destroyed via reaction of the water with a plurality of cationic sites of the media 18, which may comprise, as an illustrative example only, 2×10⁹ cationic sites per μm². According to an embodiment, the cartridge 10 is configured to comprise sufficient media contacting the fluid exiting the outlet 16 to kill 99.99999% of colony forming units (cfu) of pathogenic bacteria in less than one second. The media 18 may continue to disinfect fluid for two years or as much as 568,000 L of fluid.

Optionally, the cartridge 10 may include a pre-filter 20 and/or a post-filter 22. If included, the pre- filter 20 and/or the post-filter 22 may include a porous membrane or filter to retain the media 18 while allowing fluid flow. In addition or alternatively, the pre-filter 20 and/or the post-filter 22 may include particulate filters, activated charcoal filters, etc. FIG. 1A shows an electrolytic ozone cell 30 having an inlet 31 and an outlet 32 with a power supply 33. The ozone cell 30 can be installed in line either before or after the cartridge 10. A small residual amount of dissolved ozone is created when a positive water flow causes energy to be placed on a small anode and cathode. The residual ozone provides a highly oxidized solution capable of destruction of biofilm and is used to provide a second means of disinfection before water is delivered, for example, to a dental hand piece.

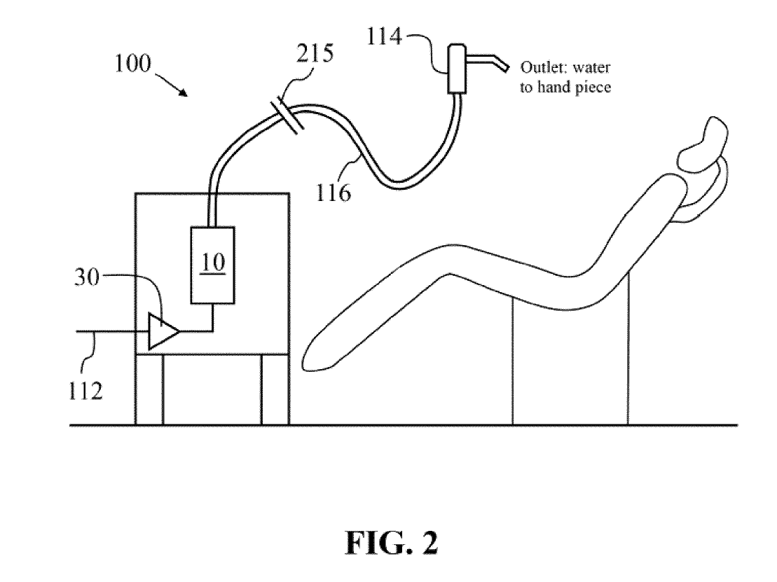

FIG. 2 is a schematic of a simplified dental care unit 100 suitable for use with an embodiment of the invention. As FIG. 2 shows, the dental care unit 100 includes the cartridge 10 and an ozone cell 30 to add dissolved ozone to a supply of fluid 112 through the cartridge 10. The flow of disinfected fluid from the cartridge 10 may then continue to flow through a dispenser 114 controlled by a technician.

Advantageously, in some embodiments, the disinfected fluid from the cartridge 10 may disinfect the dispenser 114 and any lines 116 connecting the dispenser 114 to the dental care unit 100. FIG. 2 further depicts a system for providing disinfected water, including cartridge 10 and ozone cell 30.

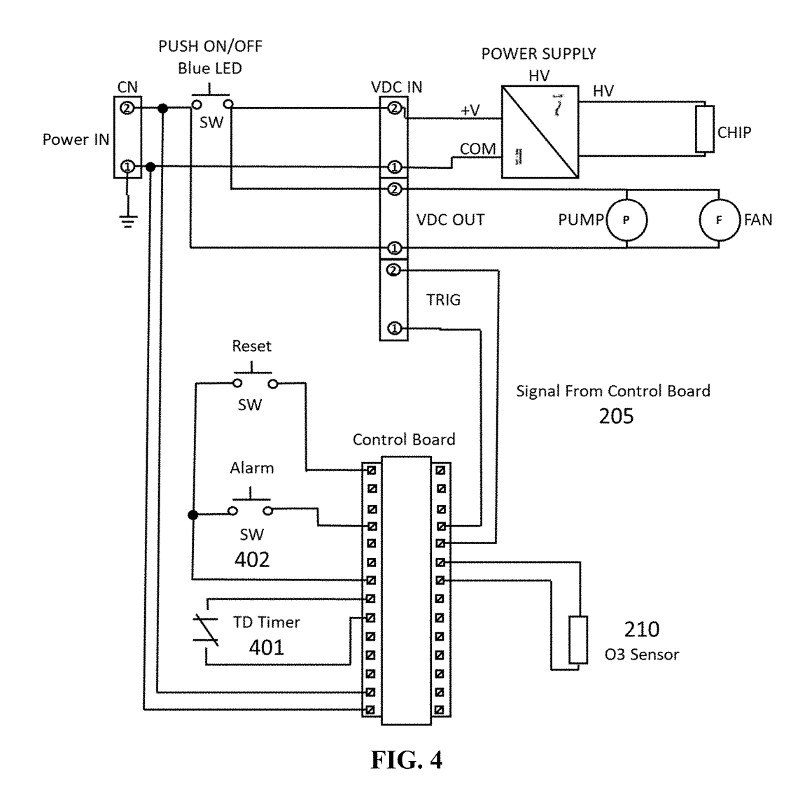

The system can include a water bottle 215. In the example shown in FIG. 2, water that that has been enriched with ozone while passing through the ozone cell 30 is conveyed to the water bottle 215, which is thereby disinfected by the ozone passing through. Sensor 210 (see FIG. 4) may be included to sense the presence and/or concentration of ozone in the air and/or water. A control board 205 may be configured to receive signals from the ozone sensor 210 and control the system to alert a technician and/or stop dispensing fluid in response to the ozone concentration falling below a predetermined level. In this regard, the control board 205 may be or may include a microprocessor.

In some embodiments of the system for providing disinfected water, the various components are in electrical connection. The various components of the system can include a normally-closed first solenoid valve, a normally-closed second solenoid valve, an air pump, an O₃ power supply, and a cooling fan. The air pump may be, for example, a fused, normally-open air pump capable of supplying fluid at a rate of about two liters per minute. The O₃ power supply can be, for example, a fused, normally-open O₃ power supply capable of supplying fluid at a rate of about three grams per hour. The cooling fan may be, for example, a fused cooling fan.

In some embodiments, the system can include a programmable logic controller. The programmable logic controller can be electrically connected to a normally-open main switch push button for operating the power supply and enabling power flow to the programmable logic controller. As power flows into the system, a main power light (e.g., a blue LED) electrically connected to the programmable logic controller receives power and is illuminated to visually signal to a technician that the system is powered. An O₃ sensor, such as the Puresense 20 device commercially available from AgO₃ (New Zealand), is also electrically connected to the programmable logic controller. The O₃ sensor measures the concentration of ozone in the fluid. In response to the concentration of ozone in the fluid being below a predetermined minimum amount, an alarm light (e.g., a red LED) electrically connected to the programmable logic controller receives power and is illuminated to visually signal to a technician that the ozone level is below the predetermined minimum amount. In further response to the concentration of ozone in the fluid being below the predetermined minimum amount, a buzzer electrically connected to the programmable logic controller receives power and is activated to auditorily signal to a technician that the ozone level is below the predetermined minimum amount. A normally-open system reset push button is also electrically connected to the programmable logic controller for “resetting” the system, for example, by operating the opening and/or closing of the first solenoid valve.

In response to the concentration of ozone in the fluid being above the predetermined minimum amount, an ozone light (e.g., a green LED) electrically connected to the programmable logic controller receives power and is illuminated to visually signal to a technician that the ozone level is above the predetermined minimum amount. A timer electrically connected to the programmable logic controller may then be activated in response to disinfecting fluid being dispensed. For example, the timer can be a three minute timer that sends a signal back to the programmable logic controller if the disinfecting fluid flows continuously for a predetermined time (e.g., three minutes). Once the signal has been sent that the disinfecting fluid has been continuously flowing for the predetermined time, the second solenoid valve may be closed to cease the flow of disinfecting fluid.

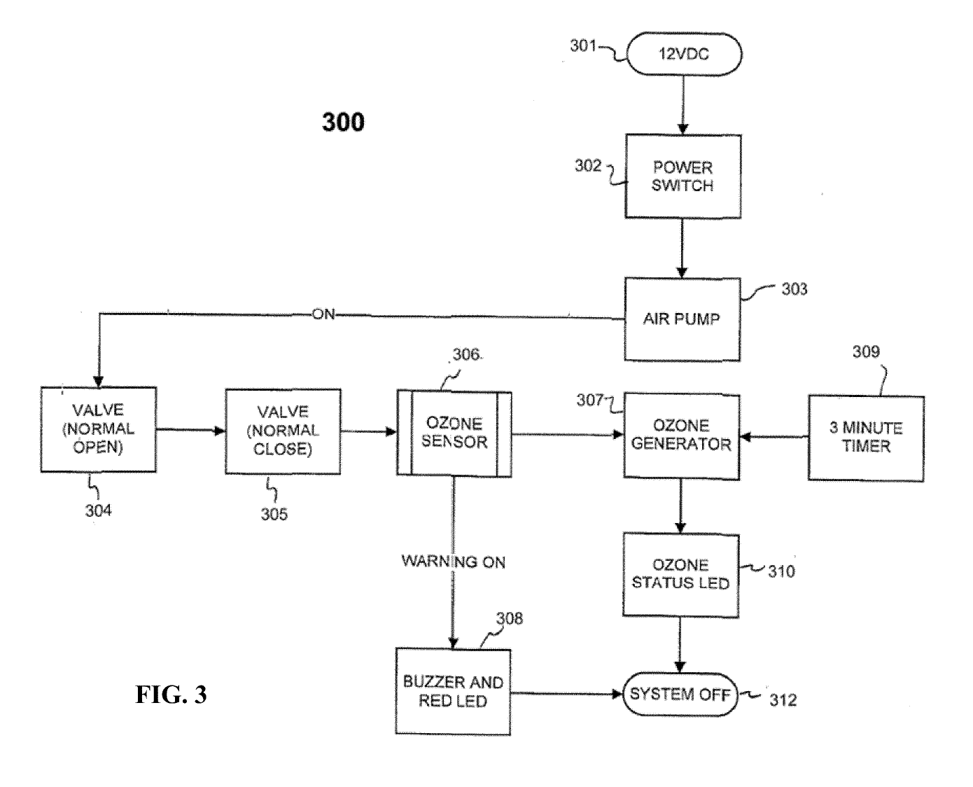

FIG. 3 is a flow diagram of a method 300 for controlling the system for providing disinfected water. As FIG. 3 shows, 12-volt DC power may be provided to the system at step 301. At step 302, power may flow to the various system components in response to engaging a main. For example, at step 303 an air pump may be supplied power in response to a technician's request for fluid.

At steps 304 and 305 the various valves may be controlled to open and close as controlled by a control board 205 shown in FIG. 4. In this manner, the flow of disinfecting fluid within the system may be controlled. At step 306 the sensor 210 may sense ozone in the fluid. In response to the concentration of ozone in the fluid being above a predetermined minimum amount, the control board 205 may trigger a visual indication (e.g., a green LED) and the disinfected fluid is allowed to proceed through the system. If the control board 205 determines the concentration of ozone is below the predetermined minimum amount, the control board 205 may trigger an alert (e.g., a red LED and/or a buzzer) and/or stop the flow of disinfected fluid.

At step 309, a timer may be initiated in response to disinfected fluid being dispensed and the timer may send a signal to the control board 205 if the disinfected fluid flows continuously for a predetermined time. For example, if the disinfected fluid flows continuously for three minutes, the timer may signal the control board 205 and the control board 205 may stop the flow of disinfected fluid by closing a valve. This permits flow control and prevents an uncontrolled flow of disinfected fluid.

In some embodiments, the control board 205 includes the various components of the system, with the components interconnected in a suitable format and conformation for integration in the dental care unit 100 shown in FIG. 2. As illustrated, the system may include the components previously described, such as an air pump, an ozone generator, a control board, an ozone sensor, a normally-open first solenoid valve, and a normally-closed second solenoid valve. In addition, the system may include an ozone destructor positioned between of the first and second solenoid valves and the ozone sensor. The system may further include a bubbler disposed within a container (e.g., a water bottle), the container positioned between the ozone generator and the first and second solenoid valves.

FIG. 4 is an electrical schematic diagram of the system for providing disinfected water in accord with an embodiment of the invention. As FIG. 4 shows, the electrical schematic diagram specifically details the ozone sensor 210 in connection to the control board 205 and the connection from the control board 205 to a timer 401 and alarm 402. In this manner, as previously described, signals from the ozone sensor 210 may be sent to the control board 205 and the control board 205 may cause the alarm 402 to sound in response to determining the concentration of ozone is outside a predetermined amount. In some embodiments, the predetermined amount of ozone is about 0.5 mg/L to about 2.0 mg/L.

In some embodiments, the water line decontamination and disinfection systems of the disclosure comprise an electronic system that monitors flow volume of water in the line. The electronic system can comprise one or more sensors to detect flow, and one or more sensors to detect solutes or contaminants in the water. The sensors are operably linked to one or more chips that monitors the flow and/or the concentrations of solutes or contaminants in the water. In some embodiments, the electronic system is configured to detect the concentration of ozone in the water and to stop the flow or alert the user when the concentration is outside a predetermined concentration range, e.g., from about 0.5 mg/L to about 2.0 mg/L. The electronic system can comprise an antenna or multiple antennae and can be figured to connect wirelessly to a computer system. In some embodiments, the electronic system monitors the flow of water and concentration of ozone or other solute or contaminant in a water line and alerts the user via signaling over a WiFi or other network connection to a user device, so as to continuously provide the user with monitoring information about how the disinfection system is working.

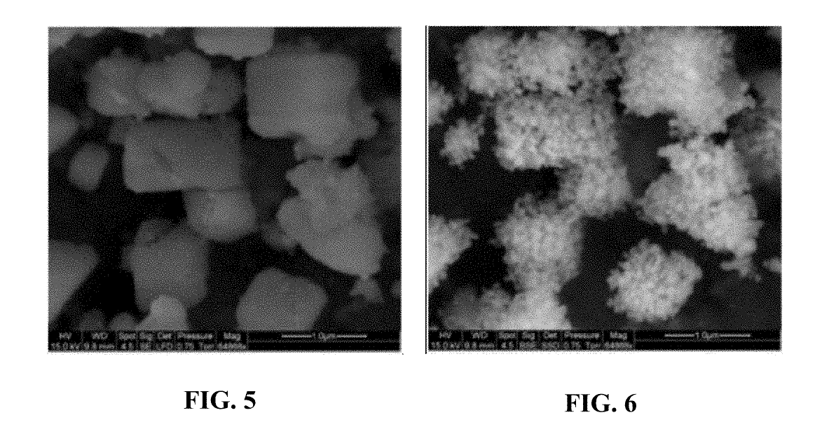

FIG. 5 is a scanning electron micrograph of the media 18 for destroying bacteria suitable for use with an embodiment of the invention. As FIG. 5 shows, media 18 may be granulated and these granules may vary in size, e.g., granules may range from about 350 μm to about 4 mm across. The surface of the media 18 appears smooth in FIG. 5, prior to exposure of an electronic potential.

FIG. 6 is a scanning electron micrograph of the media 18 showing electronic discharge in response to exposure of an electronic potential of 15.0 kV for 55 seconds. As FIG. 6 shows, in response to an electron beam of a scanning electron microscope, media 18 exhibit surface metallization in situ, giving rise to nano-aggregates having an average size of 50 nm that completely cover the surface of the media 18. This metallization is due to the interaction between the surface powerful cationic sites and the SEM beam electrons. With the knowledge that media 18 has been exposed to an electronic potential of 15.0 kV for 55 seconds, the electronic discharge of the surface cations is estimated at 2×10⁹ electrons/μm². Currently, no other material with such a cationic surface state is known.

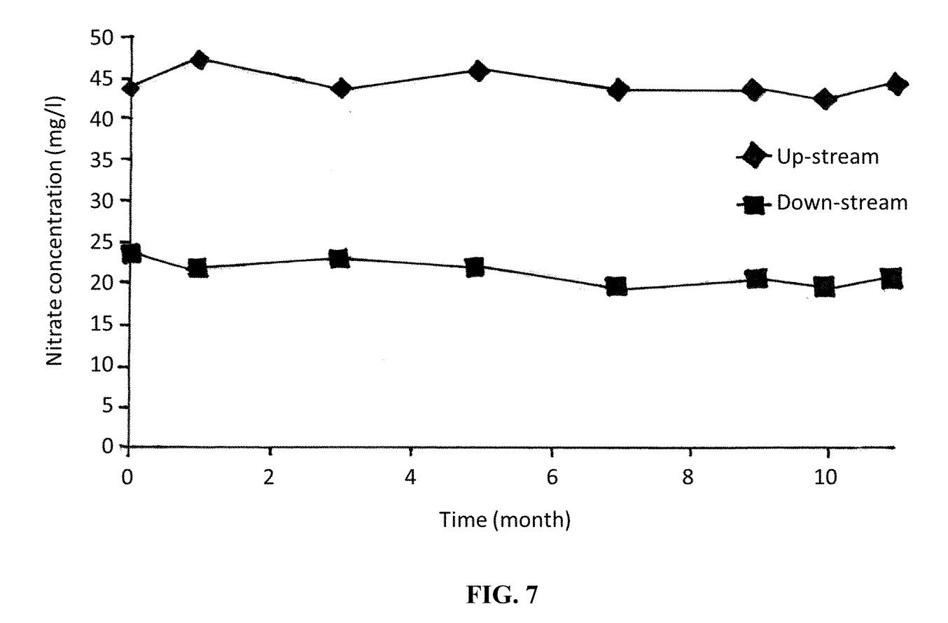

FIG. 7 plots nitrate concentration (mg/L) up-stream and down-stream of cartridge 10 according to FIG. 1 over 11 months. As FIG. 7 shows, cartridge 10 continues to effectively reduce the concentration of nitrates over the 11-month period and, advantageously in addition to providing disinfection over a period of two years and/or 568,000 L of fluid, is also configured to reduce waterborne nitrates.

The embodiments shown and described in the specification are not intended to be limiting in any way. Countless changes, modifications, or alterations to the described embodiments may be made by persons of ordinary skill in the art without departing from the spirit of the invention.

What is claimed is:

1. A water line decontamination and disinfection system comprising an ozone treatment coupled with a chemical treatment of water in a water line.

2. The system of claim 1, wherein the ozone treatment is a primary disinfection and precedes the chemical treatment.

3. The system of claim 1, wherein the ozone treatment is a secondary disinfection and follows the chemical treatment.

4. The system of claim 1, wherein the chemical treatment comprises a disinfecting media containing a cation-on-cation-on-cation surface to which the water in the water line is subjected.

5. The system of claim 1, wherein the water line is a dental water line.

6. The system of claim 1, wherein the ozone treatment and the chemical treatment are administered to the water in an in-line cartridge, the in-line cartridge comprising an inlet, an outlet, and a body; wherein the chemical treatment comprises a disinfecting media disposed in the body, the disinfecting media including a substrate comprising alumina, silicate, or combinations thereof, and a cationic coating disposed on the substrate, the cationic coating including one or more of AgO, Ag₂O, and AgC.

7. The system of claim 6 further comprising a sensor for detecting a concentration of ozone in the water.

8. The system of claim 7 further comprising a control board configured to receive a signal from the sensor and stop a flow of fluid in response to the concentration of ozone being outside a predetermined concentration range.

9. The system of claim 8, wherein the predetermined concentration range of ozone is from about 0.5 mg/L to about 2.0 mg/L.

10. A cartridge for disinfecting water, the cartridge comprising an inlet, an outlet, a body, and a disinfecting media disposed in the body, the disinfecting media including a substrate comprising alumina, silicate, or combinations thereof; and a cationic coating disposed on the substrate, the cationic coating including one or more of AgO, Ag₂O, and AgC.

11. The cartridge of claim 10, wherein the substrate is granulated.

12. The cartridge of claim 10, wherein the disinfecting media comprises a cationic surface.

13. A method of disinfecting fluid, the method comprising generating a flow of fluid, and conveying the flow of fluid through a cartridge, the cartridge including an inlet, an outlet, a body, and a disinfecting media disposed in the body, the disinfecting media including a substrate comprising alumina, silicate, or combinations thereof; and a cationic coating disposed on the substrate, the cationic coating including one or more of AgO, Ag₂O, and AgC.

14. The method of claim 13 further comprising sensing a concentration of ozone in an outlet of the cartridge, and stopping the flow of fluid in response to the concentration of ozone being outside a predetermined concentration range.

15. The system of claim 14, wherein the predetermined concentration range of ozone is from about 0.5 mg/L to about 2.0 mg/L.

16. The method of claim 13, wherein the water is in a water line.

17. The method of claim 16, wherein the water line is a dental water line.
